(19) United States
(12) Patent Application Publication
(10) Pub. No.: US 2009/0244764 A1
(43) Pub. Date: Oct. 1, 2009

(54) BALANCE CORRECTION APPARATUS AND BALANCE CORRECTION METHOD

(75) Inventors: Shigeyuki Kotake, Kawasaki (JP); Nobuyoshi Nakayama, Kawasaki (JP); Toru Kohei, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/481,896

(22) Filed: Jun. 10, 2009

Related U.S. Application Data
(63) Continuation of application No. PCT/JP2006/324722, filed on Dec. 12, 2006.

(51) Int. Cl. G11B 15/18

(52) U.S. Cl. 360/71; G9B/15.021

(57) ABSTRACT

A balance correction apparatus is configured to correct weight imbalance around an axis of a spindle motor, and includes a piezoelectric actuator configured to apply an impact to a housing, a controller configured to generate as a rectangular wave a force profile that represents an acceleration applied to the housing by the piezoelectric actuator, and a waveform generator configured to generate a voltage waveform configured to drive the piezoelectric actuator, by integrating the force profile twice. The rectangular wave has a first acceleration after a leading edge and a second acceleration after a trailing edge. The first acceleration enables the disc to move relative to the spindle motor and the housing. The second acceleration enables the disc to move together with the spindle motor and the housing.

This application is a continuation based on International Application No. PCT/JP2006/324722 filed Dec. 12, 2006.

### BACKGROUND OF THE INVENTION

1. Field of the Invention

The present invention relates generally to driving control of a disc drive, and more particularly to a balancing apparatus and method configured to correct a weight imbalance (generally referred to as “imbalance” or “unbalance”) around an axis of a spindle motor. The present invention is suitable, for example, for an apparatus and method configured to correct rotational balances of discs mounted on a hard disc drive (“HDD”).

2. Description of the Related Art

Recently, the HDD is increasingly required to have a large capacity and stable recording and reproducing actions. For the large capacity, the HDD has a disc having an increased recording density. For the stable recording and reproducing actions, a high head positioning precision is necessary. For the improved head positioning precision, it is necessary to correct the imbalance so as to restrain vibrations applied to the discs and deformations of the discs.

A primary factor of the imbalance is an imbalance between the discs and the movable part of the spindle motor. A method of moving the discs to balanced positions is one known imbalance correction method. For example, Japanese Patent Laid-Open No. 9-161394 proposes a balance correction apparatus that applies a vibration to the housing that is configured to house the discs and the spindle motor, and displaces the discs. The balance correction apparatus applies a rectangular-wave control voltage to a piezoelectric element, displaces the piezoelectric element, and applies an impact to the housing. The impact force is controlled by controlling a displacement amount of the piezoelectric element.

The conventional balance correction apparatus has several problems: Firstly, the imbalance correction needs a long time, because the rectangular-wave driving voltage has a short operation time period of the vibration applied by the piezoelectric element. As a result, the piezoelectric element needs to repeatedly apply impacts many times to the housing, lowering the throughput. In addition, the impact affects other components, such as an acceleration sensor, and thus more impacts may damage other components mounted in the balance correction apparatus. Secondly, a contact state between the piezoelectric element and the housing is likely to change when the deformation amount of the piezoelectric element is adjusted so as to adjust the impact force. For example, when the displacement amount of the piezoelectric element is small, the impact of the piezoelectric element is absorbed in the internal mechanism, and the imbalance correcting precision lowers. Thirdly, since a leading edge and a trailing edge of a rectangular wave are so steep that the piezoelectric element abruptly displaces, the impact applied to the housing instantly increases and the imbalance correcting precision lowers.

### SUMMARY OF THE INVENTION

The present invention provides a balance correction apparatus and method configured to quickly and precisely correct an imbalance.

A balance correction apparatus according to one aspect of the present invention is configured to correct a weight imbalance around an axis of a spindle motor that is configured to drive a disc in a disc drive. The balance correction apparatus includes a piezoelectric actuator configured to apply an impact to a housing that is configured to house the disc and the spindle motor, a controller configured to generate as a rectangular wave a force profile that represents an acceleration applied to the housing by the piezoelectric actuator, the rectangular wave having a first acceleration after a leading edge and a second acceleration after a trailing edge, the controller setting the first acceleration so that the disc can move relative to the spindle motor and the housing, and the controller setting the second acceleration so that the disc can move together with the spindle motor and the housing, and a waveform generator configured to generate a voltage waveform configured to drive the piezoelectric actuator, by integrating the force profile twice. This balance correction apparatus generates a voltage waveform used to drive the piezoelectric actuator by integrating the force profile as a rectangular wave twice, and does not use the rectangular wave as it is for the driving voltage waveform of the piezoelectric actuator. Therefore, a continuing time period of the first acceleration can be made longer. Moreover, by setting the second acceleration such that the disc can move together with the spindle motor and the housing, a deterioration of a balance correction in the trailing action can be prevented.

Preferably, the piezoelectric actuator has an equal displacement amount whenever the piezoelectric actuator applies each impact. Since the piezoelectric actuator has an equal displacement amount whenever the piezoelectric actuator applies each impact, a contact state between the piezoelectric actuator and the housing does not change. Therefore, an impact that would not be absorbed in the internal mechanism can be stably applied.

The balance correction apparatus preferably further includes an analog filter configured to provide a filtering process to the voltage waveform generated by the waveform generator. This configuration can prevent an unnecessary impact caused by the stepwise wave generated by the waveform generator, such as the D/A converter.

A balance correction method according to another aspect of the present invention for correcting a weight imbalance around an axis of a spindle motor that is configured to drive a disc in a disc drive, by using a piezoelectric actuator to apply an impact to a housing that is configured to house the disc and the spindle motor includes the steps of generating as a rectangular wave a force profile representing an acceleration applied to the housing by the piezoelectric actuator, the rectangular wave having a first acceleration after a leading edge and a second acceleration after a trailing edge, the first acceleration being set so that the disc can move relative to the spindle motor and the housing, and the second acceleration being set so that the disc can move together with the spindle motor and the housing, and generating a voltage waveform configured to drive the piezoelectric actuator, by integrating the force profile twice. This balance correction method also exhibits operations similar to the above balance correction apparatus.

Preferably, the voltage waveform generating step equalizes a displacement amount of the piezoelectric actuator whenever the piezoelectric actuator applies the impact to the housing. This configuration can prevent an unnecessary impact caused by the stepwise wave generated by the waveform generator, such as the D/A converter. A program that enables a computer to execute the above balance correction method also constitutes another aspect of the present invention.

Further features of the present invention will become apparent from the following description of exemplary embodiments with reference to the attached drawings.

### BRIEF DESCRIPTION OF THE DRAWINGS

FIG. 1 is a schematic sectional view of a balance correction apparatus according to one aspect of the present invention.

FIG. 2 is a block diagram of a control system in the balance correction amount shown in FIG. 1.

FIG. 3 is a flowchart for explaining a manufacturing method of an HDD according to one aspect of the present invention.

FIG. 4 is a sectional view showing discs mounted on a spindle motor in one step shown in FIG. 3.

FIGS. 5A and 5B are schematic sectional views for explaining discs that lean to the same side by their own weights.

FIG. 6 is a schematic sectional view for explaining discs that lean to the same side by a jig.

FIG. 7 is a flowchart of a balance correcting method executed by a controller shown in FIG. 2.

FIG. 8 is a timing chart among a three-phase control signal of the spindle motor obtained by the controller shown in FIG. 2, a clock signal and an index signal.

FIG. 9 is a graph showing an output of an acceleration sensor shown in FIG. 1.

FIG. 10 is a schematic sectional view of the discs and the spindle motor having no imbalance.

FIG. 11 is a schematic sectional view of the discs and the spindle motor having an imbalance.

FIG. 12A is a schematic sectional view showing a simplified model of the housing, the disc, and the spindle motor shown in FIG. 1. FIG. 12B is an exemplified waveform diagram of an acceleration applied by a piezoelectric actuator in the model shown in FIG. 12A.

FIG. 13A is a graph showing a relationship between a uniform acceleration application time period and a disc's displacement amount in the model shown in FIGS. 12A and 12B. FIG. 13B is a graph showing a relationship between the number of vibration applications and the disc's displacement amount when a time period of the uniform acceleration application is changed.

FIG. 14 is a flowchart showing details of the step 1316.

FIG. 15 is a graph showing a relationship between the acceleration and displacement of the piezoelectric actuator shown in FIG. 1.

### DESCRIPTION OF THE EMBODIMENTS

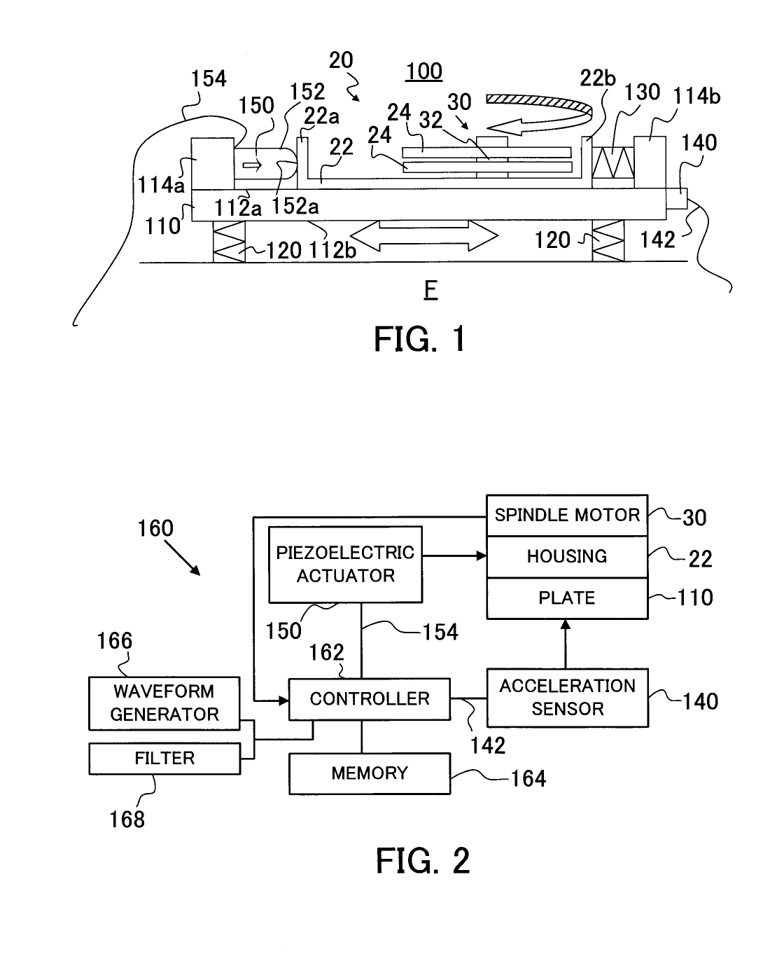

Referring now to the accompanying drawings, a balance correction apparatus 100 according to an embodiment of the present invention will be described. Here, FIG. 1 is a schematic sectional view of the balance correction apparatus 100. The balance correction apparatus 100 detects and corrects an imbalance so that the imbalance amount falls within a permissible range. The imbalance is recognized as a vibration of a housing (or disc enclosure base) 22 when a pair of discs 24 are rotated with a spindle hub 32 of a spindle motor 30 in a pre-assembled HDD 20. Therefore, the balance correction apparatus 100 detects and corrects the vibration of the housing 22. While this embodiment provides two discs 24, the number of discs 24 is not limited to two.

The balance correction apparatus 100 includes, as shown in FIG. 1, a plate 110, a plurality of spring members 120, a compression spring 130, an acceleration sensor 140, a piezoelectric actuator 150, and a control system 160 not shown in FIG. 1.

The plate 110 is a box member made of a material, such as aluminum or stainless steel, and supports the housing 22 that houses a plurality of discs 24 and a spindle motor 30. The plate 110 has a rectangular bottom surface, and has sidewalls 114a and 114b around a front surface 112a. FIG. 1 shows only the left sidewall 114a and the right sidewall 114b. A bearing and rubber may be inserted between the front surface 112a of the plate 110 and the housing 22. The plate 110 supports the piezoelectric actuator 150 and the housing 22.

The spring members 120 serve to prevent attenuations of the vibration when the spindle motor 30 is driven, and support the plate 110. The spring members 120 enable the plate 110 to integrally vibrate with the housing 22. In the balance correction apparatus 100, the plate 110 that supports the piezoelectric actuator 150, and the housing 22 vibrate as one member, but only the housing 22 may vibrate.

In this embodiment, four spring members 120 are connected at four points of the bottom surface 112b of the plate 110 symmetrically. The rectangle made by connecting centers of four spring members 120 is similar to the bottom rectangular of the plate 110. The center (or center of gravity) of the rectangle made by connecting centers of four spring members 120 approximately accords with the center of gravity of the plate 110 and the components mounted on the plate 110. Of course, the number of spring members 120 is not limited.

The spring member 120 has a spring constant k that satisfies the following Equation 1, where m is a total weight supported by or above the spring members 120, ωo is a rotating frequency of the spindle motor 30, and ωp is a resonance frequency of the housing 22 and plate 110:

ωo≦ωp=√k/m EQUATION 1

When Equation 1 is met, a reduction of the vibration of the spindle motor 30 can be prevented. In case of ωo=ωp, the amplitude of the waveform shown in FIG. 9, which will be described later, becomes excessively large due to the resonance, and thus the following equation is preferably met:

ωo<ωp EQUATION 2

In a range that satisfies Equation 2, the vibration of the spindle motor 30 does not reduce and the amplitude of the waveform shown in FIG. 9, which will be described later, becomes constant. When there are a plurality of spring members 120, k is a synthesized spring constant, and satisfies the following equation, where k₁ is a spring constant of the first spring member 120, k₂ is a spring constant of the second spring member 120, k₃ is a spring constant of the second spring member 120, . . . .

$$\frac{1}{k} = \frac{1}{{k}_{1}} + \frac{1}{{k}_{2}} + \frac{1}{{k}_{3}} + … \qquad EQUATION 3$$

One end of the compression spring 130 is engaged with the sidewall 114b, and the other end of the compression spring 130 is engaged with the outer side of the right side surface 22b of the housing 22. The compression spring 130 applies a force to the housing 22 against the piezoelectric actuator 150. The spring constant of the compression spring 130 is not limited, but is stronger than the spring constant of the spring member 120. A rubber member may be used instead of the compression spring 130. The number of compression springs 130 and the arrangement of the compression springs 130 are not limited, but they are arranged so that no moment is applied when the impact is applied to the housing 22.

The acceleration sensor 140 detects the vibration of the housing 22 and the plate 110 when the spindle motor 30 is driven. The acceleration sensor 140 is mounted onto the plate 110, and spaced from the housing 22. Therefore, the acceleration sensor 140 is not directly affected by the impact applied by the piezoelectric actuator 150 to the housing 22. The detection precision of the acceleration sensor 140 is not affected by the attachment and detachment of the housing 22. In addition, in the attachment and detachment of the housing 22, the attachment of the acceleration sensor 140 to and the detachment of the acceleration sensor 140 from the housing 22 are unnecessary, and the operability improves. If the piezoelectric actuator 150 that may be made of ceramics contacts the housing 22, the spring members 120 maintain a sufficiently high output of the acceleration sensor 140 that it is less subject to noises, improving the measurement precision.

The piezoelectric actuator or piezoelectric hammer 150 uses a piezoelectric element and point-contacts the left side surface 22a of the housing 22. The piezoelectric actuator 150 is an impact applicator that corrects the imbalance by applying the impact to the housing 22. The point contact of the piezoelectric actuator 150 with the housing 22 eliminates an alignment that would be otherwise required when they are planes, thereby improving the operability. In FIG. 1, the piezoelectric actuator 150 has a semispherical tip 152 that has a vertex 152a for contact with the housing 22. The piezoelectric actuator 150 can stably apply a predetermined impact force to the housing 22, improving the balance correction precision. The driving voltage supplied to the piezoelectric actuator 150 will be described later.

The control system 160 includes, as shown in FIG. 2, a controller 162, a memory 164, a control signal waveform generator 166, and a filter 168. The controller 162 is connected to the spindle motor 30, the memory 164, the waveform generator 166, and the filter 168. The controller 162 is connected to the acceleration sensor 140 via a signal line 142, and connected to the piezoelectric actuator 150 via a signal line 154. The controller 162 controls each component in the balance correction apparatus 100, and executes the balance correction method, which will be described later, in a relationship with this embodiment. The memory 164 includes a ROM and a RAM, and stores the balance correction method, which will be described later, and the permissible balance amount of the disc 24 in a relationship with this embodiment. The waveform generator 166 includes a D/A converter and an arbitrary waveform generator, and generates a waveform of a control signal supplied to the piezoelectric actuator 150. The filter 168 is an analog filter that provides a filtering process to a waveform generated by the waveform generator 166.

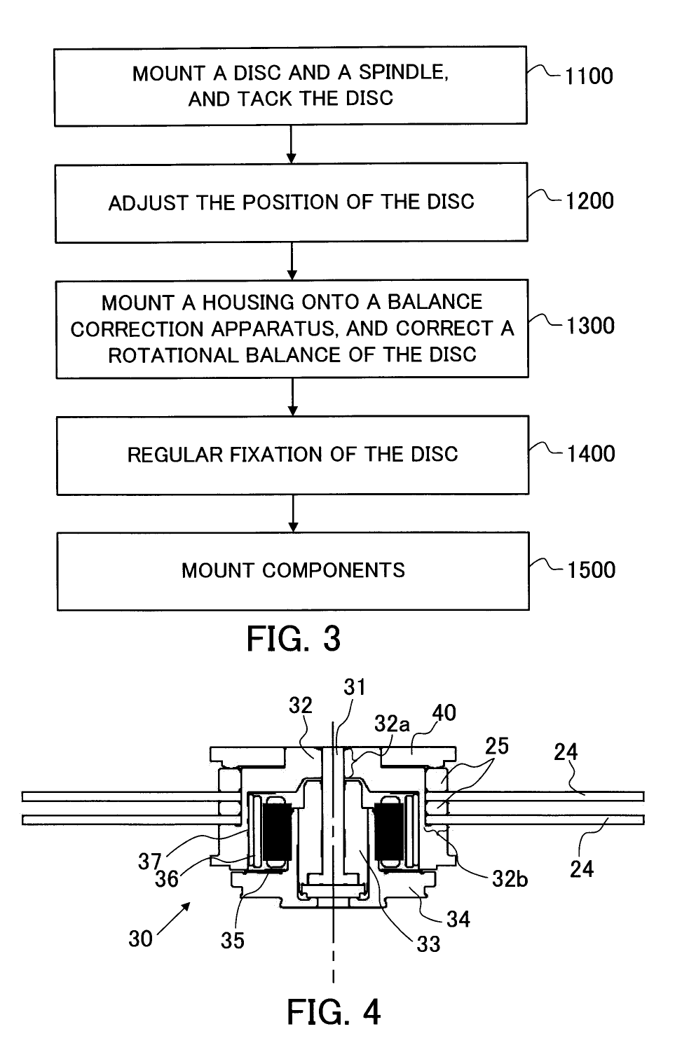

Referring now to FIG. 3, a description will be given of a manufacturing method of the HDD. First, the spindle motor 30 and one or more discs 24 are mounted onto the housing 22, and discs 24 are tacked or provisionally fixed (step 1100). More specifically, the spindle motor 30 is attached to the housing 22. Then, the discs 24 are attached to the spindle motor 30.

The spindle motor 30 includes, as shown in FIG. 4, a shaft 31, a (spindle) hub 32, a sleeve 33, a bracket 34, a core 35, and a magnet 36, a yoke 37, and other members, such as a radial bearing, and lubricant oil (fluid), and a thrust bearing. Here, FIG. 4 is a more detailed longitudinal sectional view of the spindle motor 30. The shaft 31 rotates with the discs 24. The hub 32 is fixed onto the shaft 31 at its top 32a, and supports the discs 24 on its flange 32b. The sleeve 33 is a member that allows the shaft 31 to be mounted rotatably, and is fixed in the housing 22. While the shaft 31 rotates, the sleeve 33 does not rotate and forms a fixture part with the bracket 34. The bracket 34 is fixed onto the housing 22 around the sleeve 33, and supports the core (coil) 35, the magnet 36, and the yoke 37. The current flows through the core 35, the magnet 36, and the yoke 37 constitute a magnetic circuit.

After the lower disc 24 is mounted on the flange 32b, the upper disc 24 is mounted via the spacer 25, and the clamp ring 40 is mounted via the spacer 25. The clamp ring 40 serves to clamp the discs 24 and the spacers 25 onto the spindle motor 30. The clamp ring 40 does not have a perforation hole for the detection light from an optical sensor to pass through. As described later, the controller 162 obtains a state signal or a three-phase signal from the spindle motor 30 directly, not indirectly from the optical sensor or mechanical index. As a result, the correction precision improves, and the balance correction apparatus 100 can be made small and inexpensive.

The spacers 25 maintain the intervals among the discs 24. The clamp ring 40 is screwed onto the hub 32. In FIG. 4, all screws are housed in the clamp ring 40 and not shown. In the provisional fixation, the clamp ring 40 fixes the discs 24 at such an axial force that the impact applied by the piezoelectric actuator 150 does not destroy the spindle motor 30. On the other hand, the clamp ring 40 fixes the discs 24 at such an axial force that the discs 24 do not shift in the rotation of the spindle motor 30 and the impact applied by the piezoelectric actuator 150 can correct the imbalance.

Next, positions of the discs 24 are adjusted (step 1200). This embodiment leans the discs 24 to the same side of the hub 32 of the spindle motor 30. According to the experiments by the inventors, the balance correction apparatus 100 has a difficulty in moving the discs 24 due to the frictional force differences among the discs 24 when the plurality of discs 24 are alternately arranged as shown in FIG. 11. On the other hand, when all discs 24 are aligned with the same direction or lean to the same side, as shown in FIG. 6, the frictional force difference becomes 0 among the discs 24, facilitating the adjustment by the balance correction apparatus 100.

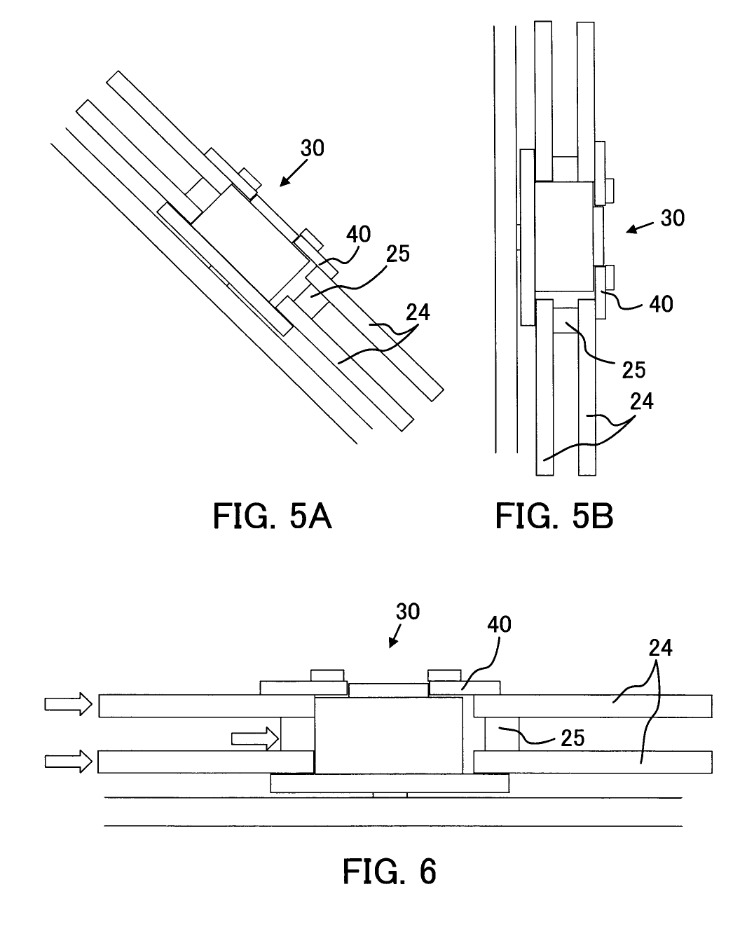

The bias may be made by inclining the housing 22, as shown in FIGS. 5A and 5B, and by leaning the discs 24 to the same direction using their own weights. FIG. 5A is a schematic sectional view showing that the housing 22 is inclined by about 45°, and FIG. 5B is a schematic sectional view showing that the housing 22 is inclined perpendicularly. Alternatively, as shown in FIG. 6, a plurality of discs 24 may be pressed in the same direction shown by arrows by using a jig. FIG. 6 is a schematic sectional view for explaining the step of leaning the discs 24 to the same direction by using the jig.

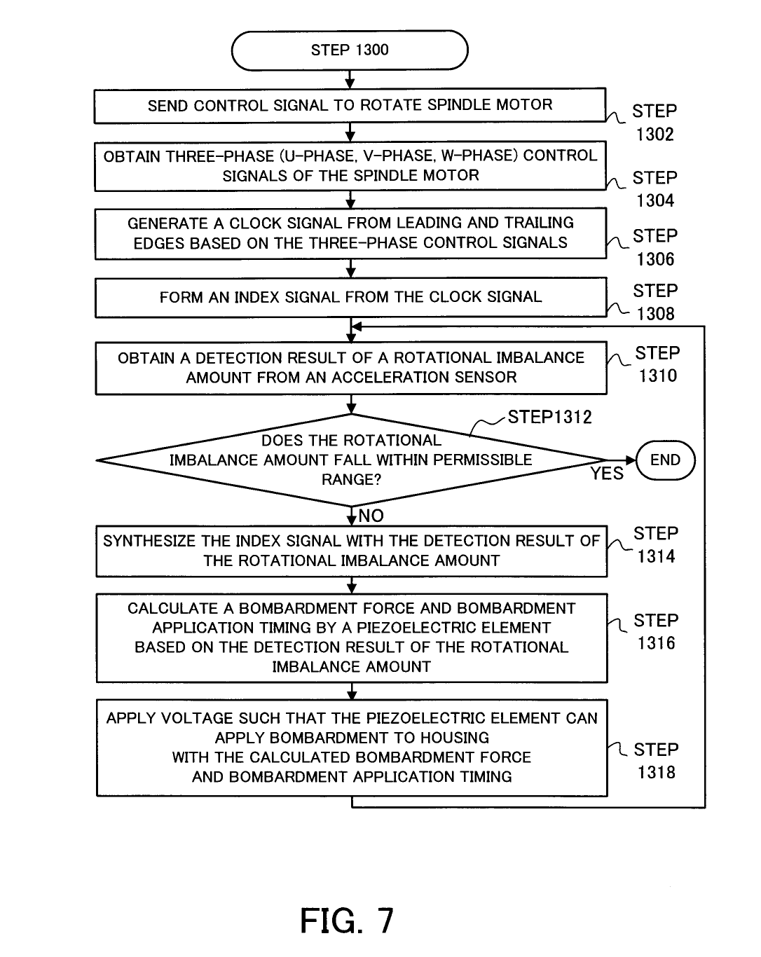

Next, the housing 22 is mounted onto the balance correction apparatus 100, and the rotational balances of the discs 24 are corrected (step 1300). Referring now to FIG. 7, a description will be given of the balance correction method executed by the controller 162. Here, FIG. 7 is a flowchart of the balance correction method.

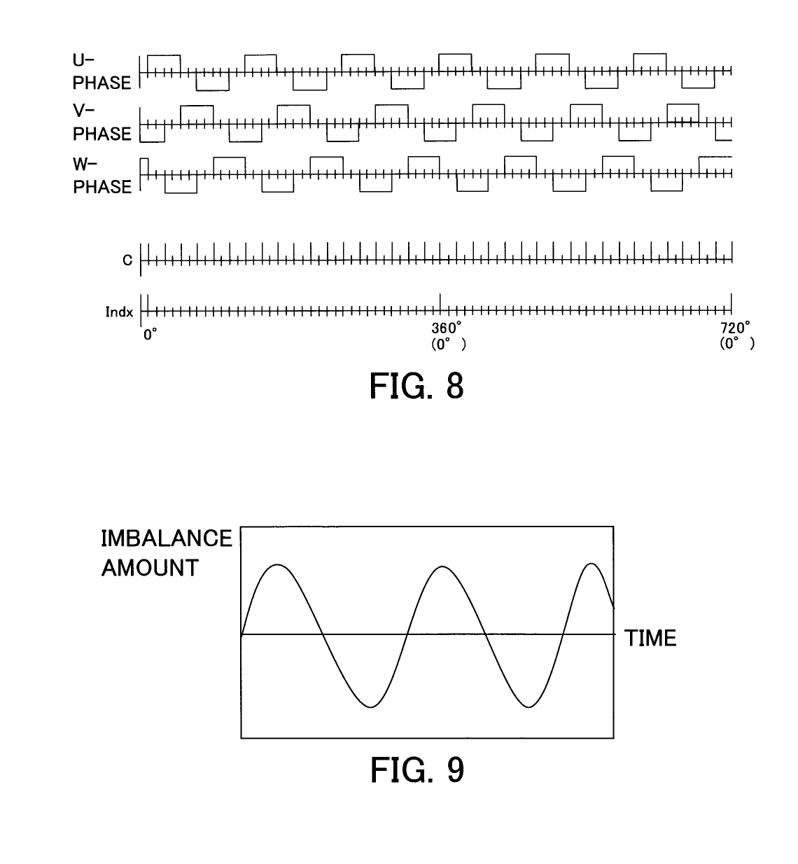

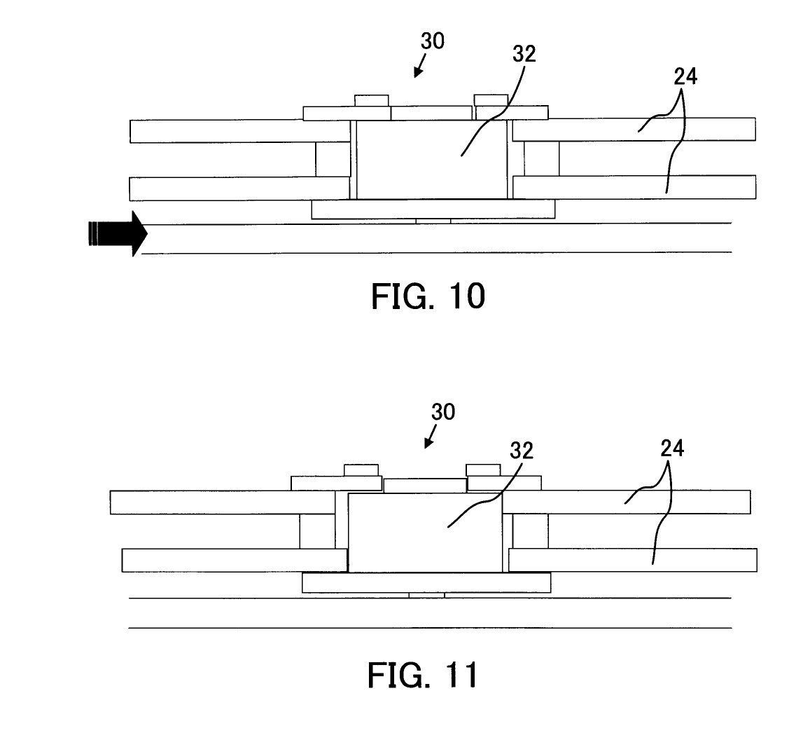

First, the controller 162 sends a control signal to the spindle motor 30 to rotate it in the state shown in FIG. 1 (step 1302). As a result, the spindle motor 30 rotates with the discs 24 in the arrow direction shown in FIG. 1. The spindle motor 30 of this embodiment is a three-phase nine-pole motor. When the controller 162 sends a rotation command to the spindle motor 30, the spindle motor 30, in response, sends a three-phase (U-phase, V-phase, W-phase) signals to the controller 162 (step 1304). FIG. 8 shows each signal. Next, the controller 162 generates a clock signal C based on the leading and trailing edges of the three-phase signals (step 1306). FIG. 8 also shows the clock signal C. The clock signal corresponds to at least one of the leading and tailing edges of the three-phase signals.

Next, the controller 162 forms an index signal Indx (rotation phase difference information) based on the clock signal (step 1308). FIG. 8 also shows the index signal Indx. Which clock corresponds to 360° is known from the structure of the spindle motor 30, i.e., three-phase nine-pole motor.

Next, the controller 162 obtains a detection result of the imbalance amount from the acceleration sensor 140 (step 1310). FIG. 9 shows a detection result of the imbalance amount, in which the ordinate axis represents the imbalance amount (acceleration) and the abscissa axis represents the time.

Next, the controller 162 determines whether the imbalance amount of the discs 24 detected by the acceleration sensor 140 falls within the permissible range stored in the memory 164 (step 1312). When the controller 162 determines that the imbalance amount falls within the permissible range (step 1312), the controller 162 ends the process. The permissible range is stored in the memory 164, and it is a predetermined range in which the amplitude of the vibration waveform is close to 0.

On the other hand, when determining that the imbalance amount are outside the permissible range (step 1312), the controller 162 detects a shift amount of the waveform in the abscissa axis direction in FIG. 9 based on the index signal Indx (step 1314). As a result, the rotation angles of the spindle motor 30 at the peaks of the sine curve are detected.

Next, the controller 162 calculates the impact force and impact application timing by the piezoelectric actuator 150 based on the detection result of the imbalance amount shown in FIG. 9 (step 1316). In other words, the controller 162 obtains values that are made by inverting the peaks from FIG. 9, and the timings corresponding to these values (or corresponding clocks) referring to FIG. 8. Next, the controller 162 controls the piezoelectric actuator 150, and applies the impact to the housing 22 with the calculated impact force at the calculated timings (step 1318). The impact is applied in the arrow direction in FIG. 1. A detailed calculation method of the impact force in the step 1316 will be described later.

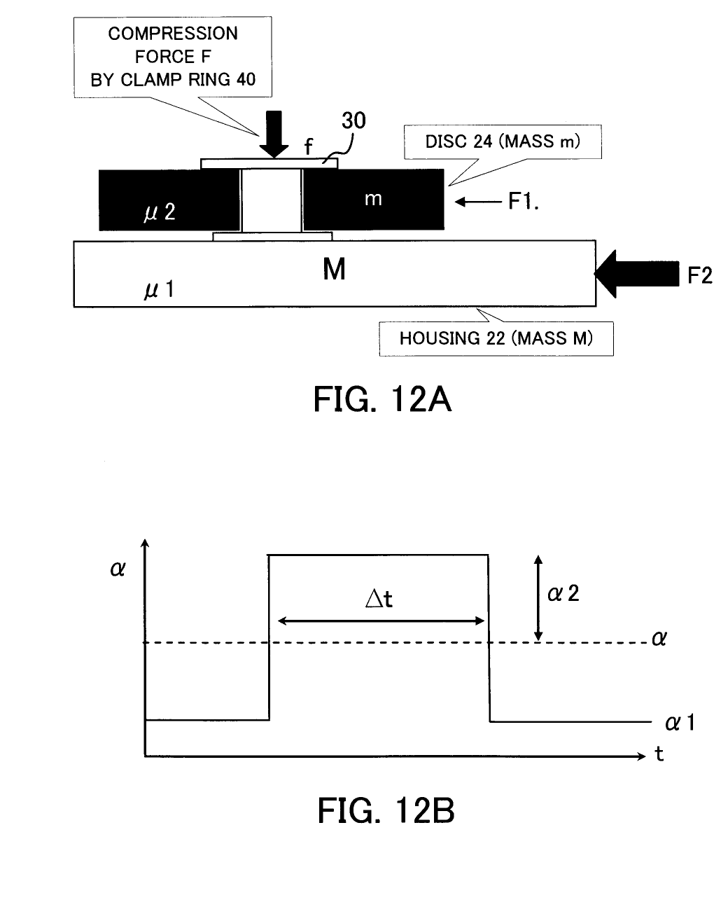

Referring now to FIGS. 12A to 14, a description will be given of a voltage waveform to be applied by the controller 162 in the steps 1316 and 1318, which enables the piezoelectric actuator 150 to efficiently move the discs 24. FIG. 12A is a schematic sectional view of a simplified model of the housing 22, the disc 24, and the spindle motor 30. Assume that the housing 22 is directly placed on a floor F, and only one disc 24 is provided. Also, assume that M is the mass of the housing 22, m is the mass of the disc 24, f is a compression force by the clamp ring 40, μ1 is a coefficient of static friction between the housing 22 and the floor F, and μ2 is a coefficient of static friction between the disc 24 and the spindle motor 30.

The force F1 necessary to move the disc 24 is defined as follows:

F1=(mg+f)μ2 EQUATION 4

The force F2 necessary to move the housing 22 is defined as follows:

F2=(M+m)α−(M+m)μ1

In order for the disc 24 to make a positional shift from the housing 22, F2>F1 is necessary, and until F2=F1, the disc 24 rotates with the housing 22 due to the inertia. When Equation 4 is made equal to Equation 5, α is defined as follows:

α={(mg+f)μ2+(M+m)μ1}/(M+m) EQUATION 6

When the piezoelectric actuator 150 applies to the housing 22 a vibration at an acceleration α1 greater than α, the disc 24 provides a positional offset at an acceleration α2:

α2=α1−α

When the waveform of the acceleration α1 is a rectangular wave shown in FIG. 12B, a moving amount x of the disc 24 is given as follows, where Δt is a continuing time period of the acceleration α2: Here, FIG. 12B is a waveform diagram of the acceleration α1 applied by the piezoelectric element 150.

X=½(α2·Δt²) EQUATION 8

It is therefore necessary to increase the time period Δt so as to increase the moving amount x.

The inventors have confirmed this effect through an experiment:

### Example 1

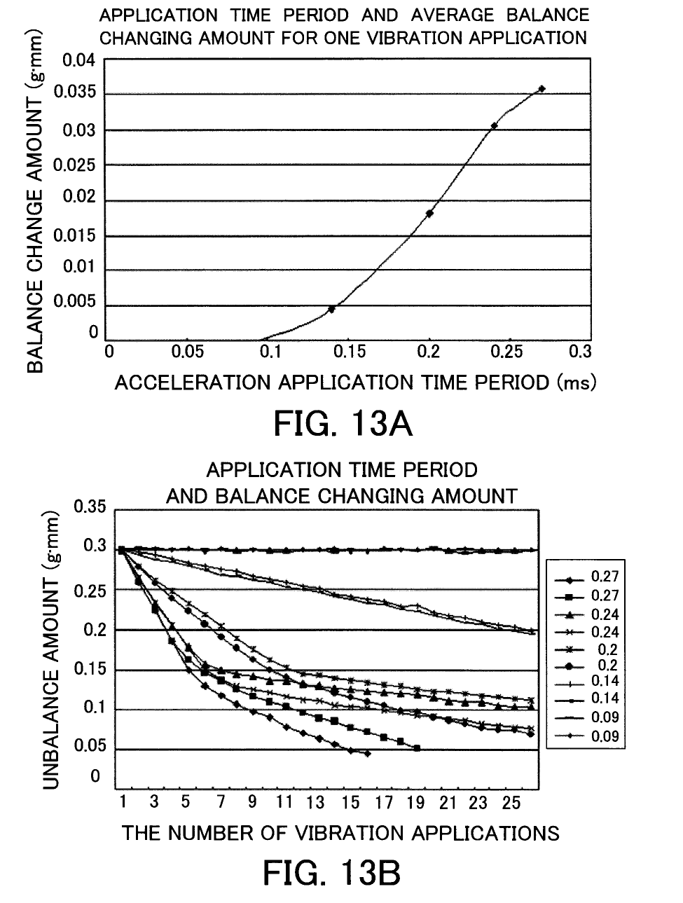

In the model shown in FIGS. 12A and 12B, a displacement amount or a moving amount x of the disc 24 is investigated with a uniform acceleration α1>α when the application time period Δt is changed. FIG. 13A shows the result. In FIG. 13A, the abscissa axis denotes Δt(ms), and the ordinate axis is the moving amount x. It is understood from FIG. 13A that a longer application time period Δt results in a longer moving amount x of the disc 24. FIG. 13B is a graph showing a relationship between the number of vibration applications by the piezoelectric actuator 150 and the displacement amount or the moving amount x of the disc 24 when the application time period Δt (ms) is changed from 0.09 ms to 0.27 ms. FIG. 13B shows results of two experiments with an identical application time period Δt. It is understood from FIG. 13B that a longer application time period Δt would reduce the number of vibration applications.

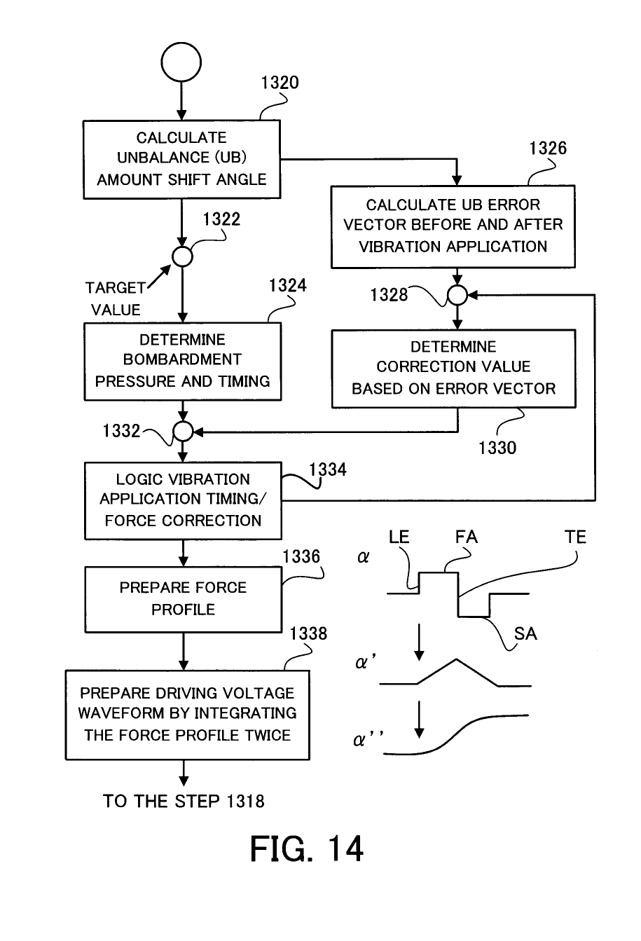

Referring now to FIG. 14, a detailed description will be given of the step 1316. Initially, shift angle of the imbalance amount is calculated based on the result of the step 1314 (step 1320). Next, the imbalance amount is compared with the target value (step 1322), and the impact force and the timing are determined (step 1324). Since the provisional fixation force by the clamp ring 40 (step 1100) and the coefficient of static friction μ1 between the disc 24 and the spindle motor 30 scatter among the HDDs 20, it is necessary to correct the result determined by the step 1324 by using the past correction results.

In calculating a correction value, an error vector of the imbalance amounts before and after the vibration is applied is calculated (step 1326) and compared with the past error vector (step 1328), and the correction value is determined (step 1330). The correction value determined by the step 1330 is compared with the impact force and the timing determined by the step 1324 (step 1332), and the impact force and the timing determined by the step 1324 are corrected (step 1334). A force profile representative of the acceleration applied to the housing 22 by the piezoelectric actuator 150 is prepared based on the result of the step 1334, as shown in FIG. 12B (step 1336).

An example of the force profile of the rectangular wave is shown on the side of the step 1336. The force profile returns to the original state through a uniform acceleration FA after a leading edge LE and a uniform acceleration SA after a trailing edge TE. Δt is a time period for which the uniform acceleration FA continues, and this embodiment sets this time period longer than ever.

The controller 162 sets the uniform acceleration FA so that the disc 24 moves relative to the spindle motor 30 and the housing 22. In other words, the uniform acceleration FA has a magnitude of α2 greater than a in FIG. 12B. In addition, the controller 162 sets the uniform acceleration SA so that the disc 24 can move together with the spindle motor 30 and the housing 22. In other words, the uniform acceleration SA has a magnitude smaller than a in FIG. 12B. By setting the uniform acceleration SA such that the disc 24 can move together with the spindle motor 30 and the housing 22, the trailing action is prevented from deteriorating the balance correction.

Next, the controller 162 instructs the waveform generator 166 to prepare a driving voltage waveform applied to the piezoelectric actuator 150, as a waveform made by integrating the force profile twice (step 1338). Since a displacement is made by integrating the acceleration twice, the driving voltage waveform corresponds to the displacement profile of the piezoelectric actuator 150.

Since the prior art use a rectangular wave signal for a control signal for the voltage applied to the piezoelectric actuator 150 in the step 1338, the displacement profile of the piezoelectric actuator 150 also has a rectangular displacement. As a result, a vibration application time period is very short, and the imbalance correction requires a long time. On the other hand, since this embodiment uses one made by integrating the force profile twice for the driving voltage waveform of the piezoelectric actuator 150, a desired continuing time period Δt which has been set at the time of setting of the force profile can be secured.

Moreover, the controller 162 provides such control that a displacement amount at the uniform acceleration FA application time of the piezoelectric actuator 150 can be equal for each impact application time. Thereby, a contact state between the housing 22 and the piezoelectric actuator 150 becomes stable, and scattering of the correction effect reduces.

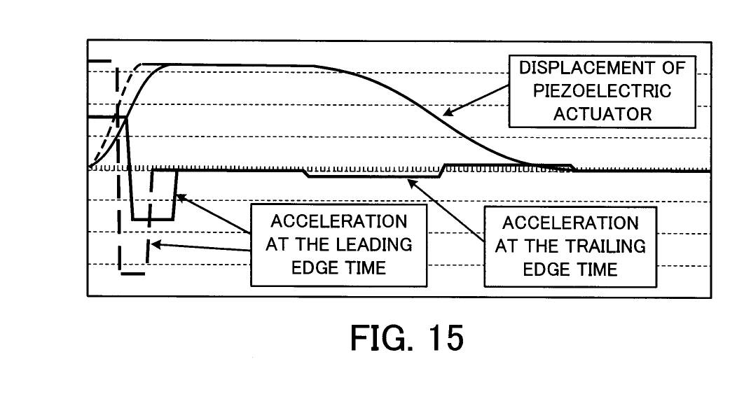

FIG. 15 is a graph showing a relationship between the acceleration and the displacement of the piezoelectric actuator 150. It is understood that an acceleration after the trailing edge is set lower than an acceleration after leading edge or two types of impacts shown by a dotted line and a solid line. For the two types of leading edges, the accelerations after the trailing edges approximately accord with each other. The piezoelectric actuator 150 shows a displacement shown by a dotted line for the acceleration after the leading edge shown by a dotted line. Similarly, the piezoelectric actuator 150 shows a displacement shown by a solid line for the acceleration after the leading edge shown by a solid line. The displacement profile indicates that a displacement at the leading time is steeper than that at the trailing time. Thereby, a displacement of the piezoelectric actuator 150 at the trailing time does not apply the impact to the housing 22.

This embodiment can correct the imbalance with a smaller number of vibration applications, as described with reference to FIG. 13B. In addition, this embodiment can maintain constant a displacement amount of the piezoelectric actuator 150, and prevents an absorption of the impact force in the balance correction apparatus, contrary to the prior art. This embodiment reduces an occurrence of an impact at the trailing time by changing the uniform accelerations FA and SA and by making different the time constant of the leading time from the time constant of the trailing time. Moreover, a waveform of a control signal in which a displacement profile prepared by the waveform generator 166 becomes a uniform acceleration motion has generally a set of stepwise waves. Thus, leading becomes steep and applies an impact force to the housing 22 at the leading time. In order to prevent this problem, the controller 162 uses the filter 168, extends the through rate at the leading time, and restrains an occurrence of the impact.

Turning back to FIG. 3, the clamp ring 40 is finally or regularly fixed in the balance-corrected housing 22 so as to tightly fix the discs 24 (step 1400). In the regular fixation, the clamp ring 40 fixes the discs 24 at such an axial force that the impact applied by the piezoelectric actuator 150 cannot shift the discs 24 or the impact guaranteed by the HDD 200 can be maintained.

Next, the head stack assembly (“HAS”) and other components are mounted in a clean room, then a printed board and other components are attached to the back surface of the housing 22, and the HDD 20 is completed (step 1500). The completed HDD 20 can guarantee high head positioning precision.

Further, the invention is not limited to the disclosed exemplary embodiments, and various modifications and variations may be made.

The present invention can provide a balance correction apparatus that can quickly and precisely correct the imbalance.

What is claimed is:

1. A balance correction apparatus configured to correct a weight imbalance around an axis of a spindle motor that is configured to drive a disc in a disc drive, said balance correction apparatus comprising:
a piezoelectric actuator configured to apply an impact to a housing that is configured to house the disc and the spindle motor;
a controller configured to generate as a rectangular wave a force profile that represents an acceleration applied to the housing by the piezoelectric actuator, the rectangular wave having a first acceleration after a leading edge and a second acceleration after a trailing edge, the controller setting the first acceleration so that the disc can move relative to the spindle motor and the housing, and the controller setting the second acceleration so that the disc can move together with the spindle motor and the housing; and
a waveform generator configured to generate a voltage waveform configured to drive the piezoelectric actuator, by integrating the force profile twice.

2. The balance correction apparatus according to claim 1, wherein the piezoelectric actuator has an equal displacement amount whenever the piezoelectric actuator applies each impact.

3. The balance correction apparatus according to claim 1, further comprising an analog filter configured to provide a filtering process to the voltage waveform generated by the waveform generator.

4. A balance correction method for correcting a weight imbalance around an axis of a spindle motor that is configured to drive a disc in a disc drive, by using a piezoelectric actuator to apply an impact to a housing that is configured to house the disc and the spindle motor, said balance correction method comprising the steps of:
generating as a rectangular wave a force profile representing an acceleration applied to the housing by the piezoelectric actuator, the rectangular wave having a first acceleration after a leading edge and a second acceleration after a trailing edge, the first acceleration being set so that the disc can move relative to the spindle motor and the housing, and the second acceleration being set so that the disc can move together with the spindle motor and the housing; and
generating a voltage waveform configured to drive the piezoelectric actuator, by integrating the force profile twice.

5. The balance correction method according to claim 4, wherein the voltage waveform generating step equalizes a displacement amount of the piezoelectric actuator whenever the piezoelectric actuator applies the impact to the housing.
